(19) United States
(12) Patent Application Publication
(10) Pub. No.: US 2014/0202235 A1
(43) Pub. Date: Jul. 24, 2014

(54) CARTRIDGE FILTER ROBUSTNESS TESTING

(71) Applicant: BHA Altair, LLC, Franklin, TN (US)

(72) Inventors: Timothy John Nicholas, Southampton (GB); Stephen David Hiner, Wiltshire (GB); Bradly Aaron Kippel, Greenville, SC (US); Charles Edward Thomas Brake, Hampshire (GB)

(73) Assignee: BHA Altair, LLC, Franklin, TN (US)

(21) Appl. No.: 13/748,809

(22) Filed: Jan. 24, 2013

(51) Int. Cl. G01N 15/08

(52) U.S. Cl. CPC G01N 15/0826
USPC 73/38

(57) ABSTRACT

A method includes providing at least one filter element in a test rig. The at least one filter element separates a clean side from a dirty side within the test rig. The pressure differential between the clean side and the dirty side is measured. The pressure differential between the clean side and the dirty side is increased by filtering particulate matter and fluid from an air flow within the test rig. The at least one filter element is cleaned. The previous three steps are repeated to replicate the conditions the at least one filter element is subjected to during substantially the entire life cycle of the at least one filter element.

### BACKGROUND OF THE INVENTION

1. Field of the Invention

The invention relates to filter testing, and specifically relates to filter testing including a combination of particulate matter and fluid during an accelerated life test.

2. Discussion of Prior Art

Filter elements can be used to provide clean fluid, such as air, to or from various devices. Such devices can include gas turbines where clean air over a long service life of the gas turbine is needed. Filter elements such as cartridge filters can be used within an inlet filter house to filter contaminants from an air flow prior to introduction into an associated gas turbine.

Robustness testing of the filter elements often included placing the filter elements into a test rig and injecting some form of particulate matter into test rig air flow. However, these robustness testing results were not effective at predicting the actual performance of the filter elements in actual filtration applications where relatively high amounts of dust and humidity were included in an inlet air flow. Dust and humidity can combine to provide a challenging filtration scenario that is often not accurately predicted by known filter element testing methods. As a result, there are benefits for continual improvements in filter robustness testing methods so as to address these and other issues.

### BRIEF DESCRIPTION OF THE INVENTION

The following summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

One aspect of the invention provides a method of testing the robustness of filters. The method includes the step of providing at least one filter element in a test rig. The at least one filter element separates a clean side from a dirty side within the test rig. The method also includes the step of measuring the pressure differential between the clean side and the dirty side. The method further includes the step of increasing the pressure differential between the clean side and the dirty side by filtering particulate matter and fluid from an air flow within the test rig. The method still further includes the step of cleaning the at least one filter element. The method also includes the step of repeating the previous three steps to replicate the conditions the at least one filter element is subjected to during substantially the entire life cycle of the at least one filter element.

Another aspect of the invention provides a method of testing the robustness of filters. The method includes the step of providing at least one filter element in a test rig. The at least one filter element separates a clean side from a dirty side within the test rig. The method also includes the step of measuring the pressure differential between the clean side and the dirty side. The method further includes the step of increasing the pressure differential between the clean side and the dirty side by filtering particulate matter and fluid from an air flow within the test rig. The particulate matter and the fluid combine to form a wet cake on the at least one filter element. The method still further includes the step of cleaning the at least one filter element. The method also includes the step of repeating the previous three steps to replicate the conditions the at least one filter element is subjected to during substantially the entire life cycle of the at least one filter element.

### BRIEF DESCRIPTION OF THE DRAWINGS

The foregoing and other aspects of the invention will become apparent to those skilled in the art to which the invention relates upon reading the following description with reference to the accompanying drawings, in which:

FIG. 1 is a schematized view of an example test rig with a torn-away portion through a housing to view filter elements installed on a plate;

FIG. 2 is a perspective view of an example filter element in the test rig of FIG. 1;

FIG. 3 is a partial cross-sectional view that relates to a view taken along line 3-3 in FIG. 2, and shows a schematic representation of longitudinal pleats within a filter media and a wet cake layer accumulated on the dirty side of the filter media; and

FIG. 4 is a top level flow diagram of an example method of testing the robustness of filters.

### DETAILED DESCRIPTION OF THE INVENTION

Example embodiments that incorporate one or more aspects of the invention are described below and illustrated in the drawings. These illustrated examples are not intended to be a limitation on the invention. For example, one or more aspects of the invention can be utilized in other embodiments and even with other types of devices. Moreover, certain terminology is used herein for convenience only and is not to be taken as a limitation on the invention. Still further, in the drawings, the same reference numerals are employed for designating the same elements.

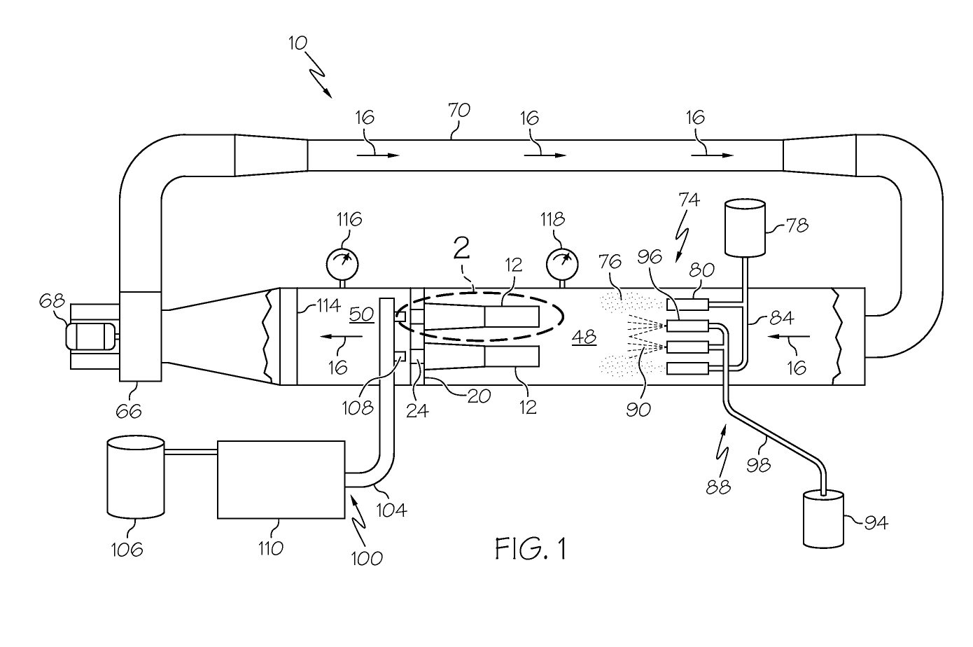

An example of a test rig 10 used in accordance with aspects of the present invention is schematically shown in FIG. 1. It is to be appreciated that the example is for illustrative purposes only and need not present specific limitations upon the present invention. The test rig 10 is used to conduct life cycle testing of a filter 12, which is one example of at least one filter element. In one example, the filter 12 can be mounted within the test rig 10 in order to be subjected to a fluid flow as represented by arrow 16. The test rig 10 can be designed to approximate the flow conditions within air filtration equipment used in actual applications. For example, the test rig 10 can approximate the flow conditions within an inlet filter house (not shown) designed to filter impurities from a fluid flow entering a gas turbine intake (not shown).

FIG. 1 shows a cut-away view of the test rig 10 to permit a view of the components located within the test rig 10. At least one filter 12 is mounted to a plate 20 which can be configured to replicate a typical tube sheet located within an inlet filter house. The plate 20 can be constructed of any suitable material, such as sheet metal. Each filter 12 is mounted to the plate 20, extending into the air flow in cantilevered fashion. While two filters 12 can be seen in FIG. 1, the test rig 10 can include additional filters 12 mounted to the plate 20 for life cycle testing. Additionally, the filters 12 can be identical to each other, or, alternatively, a number of different filters 12 can be mounted to the plate 20 for life cycle testing, or only one filter can be mounted to plate 20 for life cycle testing. Each filter 12 is associated with a passageway aperture 24 through the plate 20 as will be appreciated. Each filter 12 may be installed horizontally as shown in FIG. 1, or, alternatively they may be installed at an incline or completely vertical.

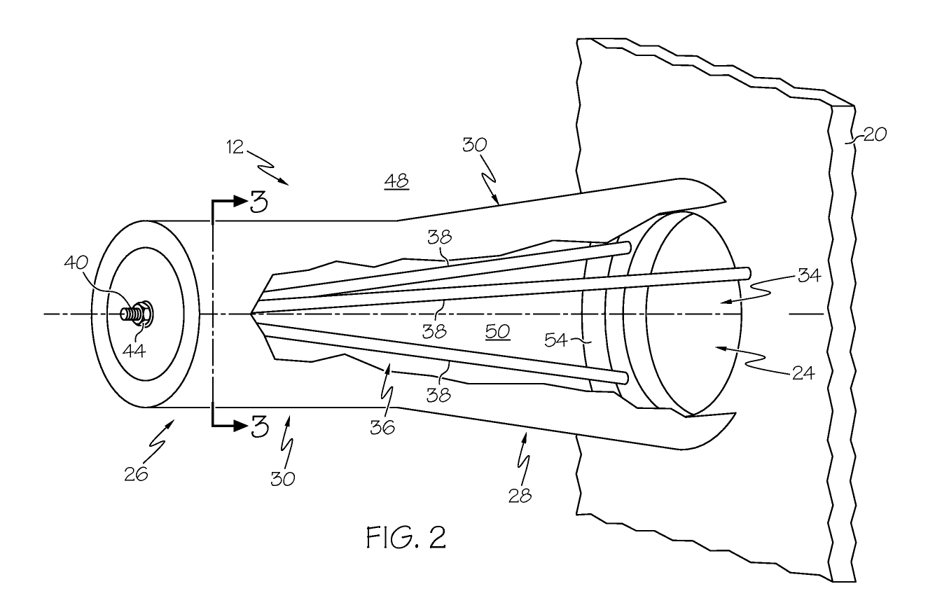

Turning to FIG. 2, the example shows filter 12 as a cartridge-type, hollow filter element, however, filter 12 can be formed to have a variety of shapes (e.g., cylindrical). The shown example filter 12 has a two part shape, with a generally cylindrical section 26 and a conical section 28. As mentioned, it is to be appreciated that the filter 12 can be formed with other shapes, including only a cylindrical section, only a conical section, only a single filter, etc.

An example filter 12 installed on the plate 20 is shown. Exterior surfaces 30 of the cylindrical section 26 and the conical section 28 serve as the airflow inlet for the filter 12, while the enlarged, open end of the conical section 28 abuts the respective aperture 24 through the plate 20 and serves as the filter outlet 34. Any suitable means can be used to secure the filter 12 against the plate 20. In one example, an internal tripod structure 36 including legs 38 can be employed to support and reinforce the filter 12. A gasketed, threaded rod 40 can be located on the upstream terminus of the internal tripod structure 36. Mating hardware 44 such as a wing nut, locking nut, etc. can be mounted to the threaded rod 40 to help keep the filter 12 in a desired location against the plate 20. Interaction between the threaded rod 40 and the mating hardware 44 can also be used to apply a force to the filter 12 in a direction generally perpendicular to the plate 20. This force can be used to at least partially compress a seal (not shown) between the filter 12 and the plate 20. The seal helps provide a barrier between a dirty side 48 (upstream) and a clean side 50 (downstream) of the air flow while also helping to prevent fluid (e.g., air) bypassing the filter 12.

The internal tripod structure 36 can be attached by any suitable means to the plate 20 at the end opposite the threaded rod 40. Each leg 38 of the internal tripod structure 36 can be attached to the plate 20 at locations relatively close to the edge of the aperture 24 in the plate 20. In one example, the legs 38 help center the filter 12 over the aperture 24 by engaging an inner surface 54 of the filter 12. In one example, the inner surface 54 of the filter 12 is a surface corresponding to the inside diameter of the filter 12 at the filter outlet 34.

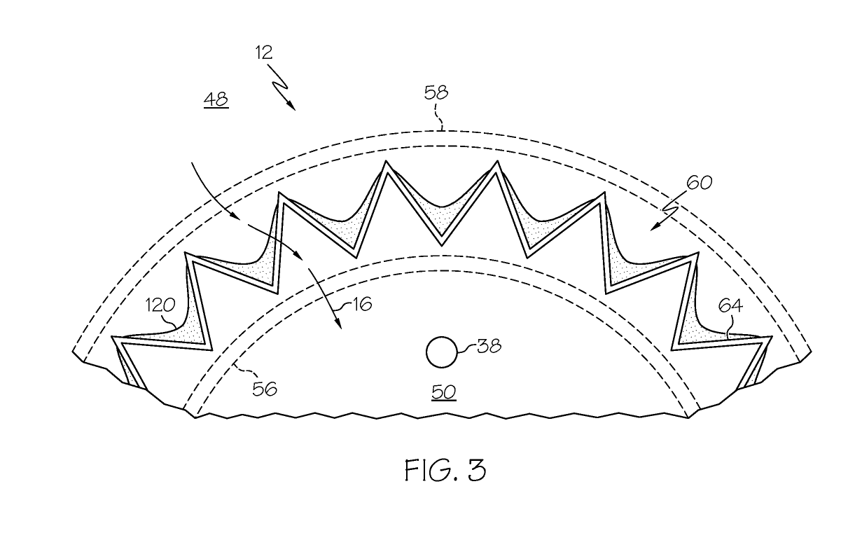

Turning to FIG. 3, a partial cross-section detail shows some of the components of an example filter 12. A cartridge-type, hollow filter element can include an internal sleeve 56 and/or an external sleeve 58. In one example, the internal sleeve 56 and the external sleeve 58 can be constructed of expanded metal, however it is to be appreciated that other materials permeable by an air flow can also be suitable for the internal sleeve 56 and the external sleeve 58. Within the annular space 60 between the internal sleeve 56 and the external sleeve 58, a filter media 64 filters undesired contaminants from the air flow (represented by arrow 16) as it flows through the filter 12. In one example, the filter media 64 can be a pleat pack as is known in the art, although other materials/configurations can also be suitable for the filter media 64. It is to be appreciated that FIG. 3 shows only a schematic representation of the filter media 64, and the folds and manner in which the filter media 64 is represented is only to show a folded or pleated filter media within the annular space 60. Often, the filter media 64 includes longitudinal pleats such that the pleats begin at the end of the filter media closest to the plate 20, extending toward the upstream terminus of the internal tripod structure 36 (best seen in FIG. 2).

Returning to FIG. 1, the plate 20 and the filters 12 provide a barrier between a dirty side 48 (upstream) and a clean side 50 (downstream) of the test rig 10. The filters 12 extend from the plate 20 toward the dirty side 48 of the air flow as represented by arrows 16. The air flow can be generated in any number of ways. In one particular example, the air flow is created by a fan 66 that can be operated by a motor 68 to create an air flow (again, represented by arrows 16) in a clockwise direction in FIG. 1. The air flow leaves the fan and is directed toward the dirty side 48 through ductwork 70. It is to be appreciated that the ductwork 70 of the test rig 10 can be of any number of cross sections and internal diameters, although the shown example includes generally cylindrical ductwork with varying diameters. Diameters and length of the ductwork 70 can be selected to optimize the performance of the test rig 10. Additionally, the ductwork 70 can be constructed of any suitable material, including material that is resistant to corrosive environments.

The test rig 10 includes dust injection equipment 74 configured to introduce dust 76 into the air flow within the test rig 10. The dust injection equipment 74 can include any number of components and/or configurations to inject dust into the air flow and FIG. 1 merely represents one example which is not intended to be limiting. The dust injection equipment 74 can include a dust storage container 78 which is connected to at least one dust injector 80 via delivery pipes 84. Dust can be transported from the dust storage container 78 along the delivery pipes 84 using any number of motive forces such as vibration, compressed air, etc. Regardless of the mechanism(s) used to transport the dust 76 from the dust storage container 78, the dust injector 80 can inject the dust 76 into the air flow within the test rig 10.

Similarly, the test rig 10 can include fluid injection equipment 88 configured to inject a fluid into the air flow within the test rig 10. In one example, the fluid injected into the air flow is water 90. The fluid injection equipment 88 can include any number of components and/or configurations to inject water 90 into the air flow and FIG. 1 merely shows one example. The fluid injection equipment 88 can include a fluid storage container 94 which is connected to at least one fluid injector 96 via delivery pipes 98. Fluid (e.g., water) can be transported from the fluid storage container 94 along the delivery pipes 98 using any number of motive forces such as gravity, pump action, etc. Regardless of the mechanism(s) used to transport the fluid from the fluid storage container 94, the fluid injector 96 can inject the water 90 into the air flow within the test rig 10. In one example, the orifice size of the fluid injector 96 can control the droplet size of the water 90 that is injected into the air flow. In one particular example, the fluid injector 96 injects a mist of water 90 into the air flow for a period of ten minutes out of every twenty minutes of testing. In another example, the fluid injector 96 injects a mist of water 90 into the air flow every 15 minutes for a selected duration of time.

While not shown, it is to be understood that the dust injection equipment 74 and the fluid injection equipment 88 can be in electrical communication with a controller (not shown). The controller can be used to control the timing of the dust 76 injection and the water 90 injection into the air flow within the test rig 10. Additionally, the controller can also control the amount of dust 76 and water 90 injected into the air flow. The amounts and timing of dust 76 and water 90 injection into the air flow can be controlled dependent upon other factors of the test rig 10 operation including sequencing as will be further described below. In another example, injection of dust 76 and/or water 90 into the air flow may be continuous throughout the robustness test operation.

The test rig 10 may also include a pulse air system 100 to deliver compressed air to the filters 12. As shown in FIG. 1, the pulse air system 100 can include an air piping system 104 which transfers compressed air from an air compressor 106 to a number of air nozzles 108, typically at least one air nozzle 108 corresponding to each passageway aperture 24 and filter 12. In one example, a compressed gas storage tank 110 can be provided between the air compressor 106 and the air nozzles 108 in order to accommodate a large requirement for compressed air in the event that the pulse air system 100 requires more compressed air than the air compressor 106 can deliver in a relatively short time between times of demand for compressed air. In one example, the air nozzles 108 will direct a quantity of compressed air to the filters 12 in a direction that is reverse to the direction of travel for the air flow as represented by arrows 16. For example, as shown in FIG. 1, compressed air is applied to the clean side 50 of the filters 12. The compressed air then travels through the filters 12 to the dirty side 48 of filters 12.

The test rig 10 can also include a protective filter 114 located within the test rig 10 to remove all or substantially all of any dust 76 that happens to pass from the dirty side 48 to the clean side 50 of the test rig 10. Removing the dust 76 from the air flow prior to the air flow reaching the fan 66 helps eliminate or reduce potential damage resulting from dust contamination and dust impingement to the fan 66 and the equipment that supports the fan. In one example, the protective filter 114 can include a high-efficiency particulate air (HEPA) filter. Typically, HEPA filters must remove 99.97% of all particles greater than 0.3 μm from the air flow passing through the HEPA filter.

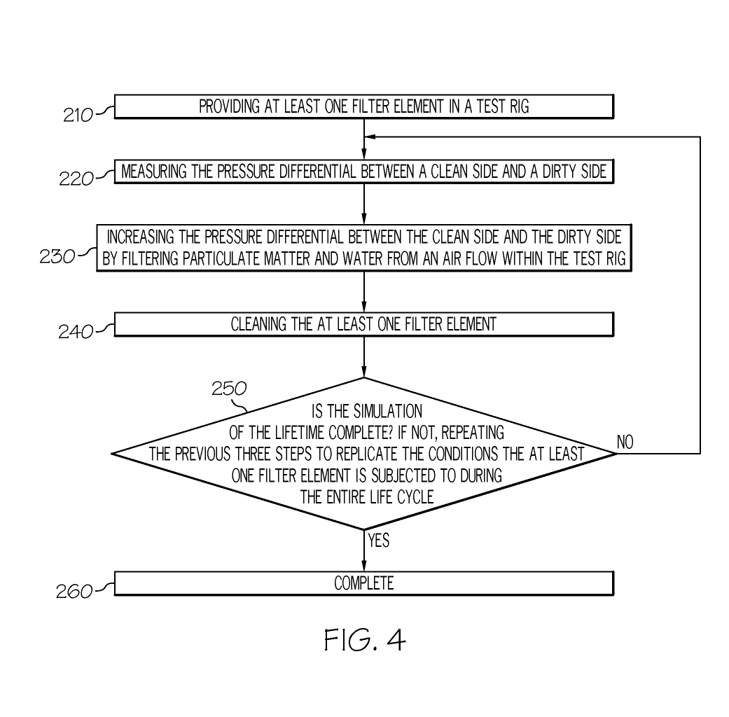

An example method of testing the robustness of filters is generally described in FIG. 4. The method can be performed in connection with the example test rig 10 and filter 12 as shown in FIGS. 1-3. The method includes the step 210 of providing a filter 12, which is an example of at least one filter element) in a test rig 10. The test rig 10 is configured such that an air flow, as represented by arrows 16, circulates through the test rig 10 and passes through the filters 12 before returning to the fan 66. As the air flow passes through the filters 12, the filter media 64 is configured to remove dirt, debris, dust particles, salt, or other contaminants from the air flow. The space upstream of the filters 12 thus becomes the dirty side 48 of the filters 12 while the space downstream of the filters 12 becomes the clean side 50 of the filters 12. As such, the filter 12 separates the clean side 50 from the dirty side 48 within the test rig 10.

The method further includes the step 220 of measuring the pressure differential between the clean side 50 and the dirty side 48. FIG. 1 shows a schematic representation of a clean side pressure sensor 116 and a dirty side pressure sensor 118 which illustrate the step of measuring the pressure differential between the clean side 50 and the dirty side 48. It is to be appreciated that the clean side pressure sensor 116 and the dirty side pressure sensor 118 can be in communication with a controller that is used to operate the test rig 10. Prior to the filters 12 filtering any particulate matter from the air flow, the pressure differential between the clean side 50 and the dirty side 48 can be relatively low.

The method further includes the step 230 of increasing the pressure differential between the clean side 50 and the dirty side 48 by filtering dust 76, which is one example of a particulate matter, from the air flow within the test rig 10. In one particular example, the filters 12 can filter water 90 from the air flow as well as the dust 76. After a period of filtering operation of the test rig 10, a pressure drop across each of the filters 12 will increase due to the accumulation of particulates, (e.g., dust 76) separated from the particulate-laden air flow and accumulate at the outer surfaces of the filters 12 as shown by particulate layer 120 in FIG. 3.

Dust 76 and water 90 are introduced to the air flow via the dust injection equipment 74 and the fluid injection equipment 88, respectively. While not shown, a controller can be used to control the timing and amount of the dust 76 and the water 90 injection into the air flow within the test rig 10. Both the timing and amount of the dust 76 and the water 90 to be injected into the air flow can be dependent upon a particular sequence of operation or other variables. One such variable is the pressure differential between the clean side 50 and the dirty side 48 of the test rig 10 as measured by the clean side pressure sensor 116 and the dirty side pressure sensor 118. The pressure differential can be defined as the pressure sensed by the dirty side pressure sensor 118 minus the pressure sensed by the clean side pressure sensor 116.

For example, at the start of a cartridge filter robustness test, fan 66 can be operated to create an airflow as represented by arrows 16 in FIG. 1. The pressure differential between the clean side 50 and the dirty side 48 of the test rig 10 can be relatively low at this time. The controller can then direct the dust injection equipment 74 to inject dust 76 into the air flow. The controller can also direct the fluid injection equipment 88 to inject a fluid, such as water 90, into the air flow. As the filters 12 filter the particulate dust 76 and the water 90 from the air flow, the pressure differential between the clean side 50 and the dirty side 48 of the test rig 10 increases. The controller can receive pressure readings from the pressure sensors 116, 118 to determine the pressure differential between the clean side 50 and the dirty side 48 and stop the injection of dust 76 and water 90 when the pressure differential reaches a desired magnitude. Other control scenarios are contemplated, such as the controller directing injection of dust 76 and water 90 for selected durations of time or selected durations of quantities of dust 76 and/or water 90.

In one particular example, the step 230 of increasing the pressure differential between the clean side 50 and the dirty side 48 continues until the pressure differential reaches a selected magnitude of pressure differential. This magnitude of pressure differential between the clean side 50 and the dirty side 48 of the test rig 10 can be selected to replicate a particular condition that the filters 12 would experience in an actual filtering application. For example, the selected pressure differential can be the maximum anticipated pressure differential that the filters 12 would be subjected to in an actual inlet filter house (not shown). The selected pressure differential can represent the pressure differential that would cause an “alarm state” in an actual filter house, for example, about 1.49 kPa (6-inches water gauge). Another example may include numbers in a range of zero to 3.738 kPa (15-inches water gauge). Further specific examples may include 450 Pa (4.6-inches water gauge) and 1.0 kPa (4-inches water gauge). As such, the controller can create a condition within the test rig 10 replicating the maximum anticipated pressure differential that the filters 12 would be subjected to during an actual filtration application.

In one example of the method, the type of dust 76 and the quantity of water 90 can be selected to replicate particular environmental conditions that may be found in an actual application. For example, the dust 76 can be selected to replicate a particular airborne particulate matter found in a generally dusty environment such as Dubai, UAE. Furthermore, the quantity of water 90 injected into the air flow can be selected to replicate the humidity of a particular environment or fog. Still further, the amount and types of dust 76 and water 90 injected into the air flow can be selected to create a particular mix ratio. For example, selected amounts of dust and water can be chosen to effectively create a particulate layer 120 forming a wet cake (best seen in FIG. 3) over the surface of the filter 12 to replicate conditions that may be seen in an actual inlet filter house. In one particular example, the dust 76 can be selected to mix with and/or absorb an amount of water 90 to create a particulate layer 120 forming a wet cake with particular properties. One example dust 76 that can mix with water 90 to create a particulate layer 120 forming a wet cake is fine marble dust that can absorb a quantity of the water 90. In one example, the mixing of the dust 76 and the water 90 is similar to making a clay-like substance.

The method also includes the step 140 of cleaning the filters 12. FIG. 1 illustrates one example of a pulse air system 100 as previously described. The pulse air system 100 is configured to provide a reverse cleaning pulse of compressed air or other suitably pressurized gas and direct the pulse periodically into each filter 12 through its filter outlet 34 (best seen in FIG. 2). In general, the pulse air system 100 delivers a sufficient flow of fluid (e.g., compressed air) to clean the filters 12. By “pulse”, it is meant a flow of a sufficient volume of gas at a pressure sufficient to overcome the filtering operation flow of particulate-laden air flow on the dirty side 48 for a limited time duration. The pulse can include any number of various pressures and last for any number of various times.

The volume flow from each of the air nozzles 108 at a selected pressure is calculated to be sufficient to overcome the operational filtering flow (e.g., air flow) through the respective filters 12 and to dislodge or remove all or a portion of the dust 76 particulates from the outer surface of the filters 12. It is possible that the reverse cleaning pulse is delivered while the air flow continues to flow around the test rig 10. The cleaning pulse locally overcomes the air flow through the filters 12. It is to be appreciated that the reverse cleaning pulse can be done for all of the filters 12 at one time, or it can be done in any other pattern, such as a top row of two filters 12 and then a bottom row of two filters 12.

The cleaning pulse emerging from the nozzles 108 can create a pressure wave along the longitudinal extent of the filters 12. Due to the suddenly occurring pressure change and the reversal of the flow direction, the filters 12 and the accumulated particulate layer 120 are forced radially outward. The accumulated particulate buildup is separated from the outer surfaces of the filters 12 and can fall to the bottom of the test rig interior.

The method further includes the step 250 which results in repeating steps 220, 230, and 240 until the simulation of the lifetime, or life cycle, of the filters 12 is complete. After the filters 12 have been subjected to the reverse cleaning pulse, the controller can then direct the clean side pressure sensor 116 and the dirty side pressure sensor 118 to measure the pressure differential between the clean side 50 and the dirty side 48. The process can then continue by increasing the pressure differential between the clean side 50 and the dirty side 48 by filtering particulate matter from the air flow within the test rig 10. In one example, the particulate matter can include the dust 76 and the water 90 injected into the air flow as described above. Filtering the particulate matter can continue to increase the pressure differential until the processor stops the dust injection equipment 74 and the fluid injection equipment 88 from injecting dust 76 and water 90 into the air flow. In one example, the controller allows the dust injection equipment 74 to continuously inject dust 76 into the air flow during the robustness test. In this example, it can be desirable to load the filters 12 with the dust 76 and water 90 combination in a wet-cake as quickly as possible in order to subject the filters 12 to a maximum pressure differential in a relatively short period of time. The selected pressure differential can represent the pressure differential that would cause an “alarm state” in an actual filter house, for example, about 1.49 kPa (6-inches water gauge), or any of the above mentioned range/values. The method can then repeat the step 240 of cleaning the filters 12 as previously described.

The repetition of the steps of measuring the differential pressure, increasing the differential pressure, and cleaning the filters 12 can continue until the entire anticipated life cycle of the filters 12 is replicated in the test rig 10. Once the simulation of the lifetime of the filters 12 is complete, the method is complete at step 260. In one example, the duration of the test replicates the number of cleaning operations, or reverse cleaning pulses that are experienced by the filters 12. The repetition can be conducted while the differential pressure is at or is relatively close to the maximum anticipated pressure differential subjected to the filters 12 in an actual filtering application. For example, one particular filtration application includes filters with an expected life span of approximately one year (approximately 9,000 hours). During that time, the reverse cleaning pulse operation occurs approximately every 15 minutes, or four times every hour of operation. This results in a filter test about 36,000 times to replicate substantially the entire life cycle of filter 12. Of course, testing for various models of filters 12 that experience different environments in real world applications may have different testing scenarios with different quantities of testing repetitions, and/or different time intervals between reverse cleaning pulse operation.

It is to be appreciated that the described methods of testing the robustness of filters can have relatively short time periods between the reverse cleaning pulses in order to shorten the length of time of the robustness testing. In one example, the reverse cleaning pulses can occur every ten seconds. In another example, the reverse cleaning pulses can occur every 5 seconds. As such, the robustness of the filter 12 over its entire life cycle can be tested in a period of days rather than approximately one to two years. It is to be appreciated that the reduced time between reverse cleaning pulses can require a larger air compressor 106 and/or a large gas storage tank 110 in order to meet the demand of compressed air in comparison to typical pulse air systems associated with actual inlet filter houses. In one example, the test rig 10 can include a 700 kPa (7 bar) air compressor.

The cleaning operation introduces an appreciable amount of stress to the filter media 64, often due to the repeated bending of the filter media 64 during the expansion and contraction of the filter media 64. This repeated bending can lead to micro-folds developing in the filter media 64 which act as stress risers (or stress concentrations). The stress risers can lead to micro-tears in the filter media 64 which can ultimately lead to failure of the filter, thereby allowing particulate matter to move from the dirty side of an inlet filter house to the clean side of an inlet filter house and potentially damage downstream equipment such as a gas turbine and/or its components.

The described methods of testing the robustness of filters 12 enables a test that includes a relatively high quantity of reverse cleaning pulses within a relatively short period of time while maintaining a relatively high pressure differential between the clean side 50 and the dirty side 48 of the test rig 10. Testing the filters 12 at the described highest anticipated pressure differential enables the testing party to determine or predict the life expectancy of the filters 12 in what may be termed a worst-case scenario. The worst-case scenario can include a pressure differential at or near the alarm state pressure differential as previously described over the simulated life expectancy or substantially the life expectancy of the filters with a relatively heavy loading of particulate matter on the filter media 64. The described methods of testing the robustness of filters 12 can also enable the manufacturer and end users to have a relatively high level of confidence that the filters 12 are able to filter the desired particulate matter from an air flow in the “worst-case” scenarios for the entire expected life of the filters 12.

Additionally, the relatively heavy loading of particulate matter (e.g., dust and water) on the filter media 64 can create relatively large stress amounts on the filter media 64 during the reverse cleaning pulses, thereby encouraging the creation of stress risers. If and when the stress risers lead to filter failure, the filter media 64 can be evaluated to determine whether the filter media 64 has sufficient mechanical strength to resist tearing during the life cycle of the filter 12 in order to predict the long-term life span of the filter 12. The mechanical strength of the filter media 64 can be evaluated in any of the methods as are known in the art. In one example, the evaluation can simply include examining the filter media 64 for tears, holes, signs of wear, etc.

It is to be appreciated that water is used to wet the filter media 64 and that such wetting can weaken the filter media. For example, some filter media may use binders to hold filter fibers and such binders are soluble in water. Weakening of the filter media can have an effect concerning the robustness testing.

The described methods of testing the robustness of filters 12 also allow evaluation of different pleating methods used to fold the filter media 64. Various failures of the filter media 64 and the location of the failures can help instruct the testing party as to improved methods of pleating the filter media 64. The described testing methods may also help indicate better construction methods for the filters 12.

The invention has been described with reference to the example embodiments described above. Modifications and alterations will occur to others upon a reading and understanding of this specification. Example embodiments incorporating one or more aspects of the invention are intended to include all such modifications and alterations insofar as they come within the scope of the appended claims.

What is claimed is:

1. A method of testing the robustness of filters including:
(I) providing at least one filter element in a test rig, wherein the at least one filter element separates a clean side from a dirty side within the test rig;
(II) measuring the pressure differential between the clean side and the dirty side;
(III) increasing the pressure differential between the clean side and the dirty side by filtering particulate matter and fluid from an air flow within the test rig;
(IV) cleaning the at least one filter element; and
(V) repeating steps (II) through (IV) to replicate the conditions the at least one filter element is subjected to during substantially the entire life cycle of the at least one filter element.

2. The method according to claim 1, further including the step of determining whether a filter media included within the at least one filter element has sufficient mechanical strength to resist tearing during the life cycle of the at least one filter element in order to predict the long-term life span of the at least one filter element.

3. The method according to claim 1, wherein the step of increasing the pressure differential between the clean side and the dirty side includes increasing the pressure differential to the greatest anticipated pressure differential that the at least one filter element is expected to experience during normal operation in the field.

4. The method according to claim 3, wherein the greatest anticipated pressure differential that the at least one filter element is expected to experience during normal operation in the field is within a range up to 3.738 kPa (15 inches water gauge).

5. The method according to claim 1, wherein the step of cleaning the at least one filter element includes using a pulse air system to deliver compressed air to the clean side of the at least one filter element.

6. The method according to claim 1, wherein steps (II) through (IV) are repeated with a relatively high frequency such that the entire life cycle of the at least one filter element can be replicated within a relatively short time period.

7. The method according to claim 6, wherein steps (II) through (IV) are repeated about 36,000 times to replicate substantially the entire life cycle of the at least one filter element.

8. The method according to claim 1, wherein the filter element is a cartridge filter.

9. A method of testing the robustness of filters including:
(I) providing at least one filter element in a test rig, wherein the at least one filter element separates a clean side from a dirty side within the test rig;
(II) measuring the pressure differential between the clean side and the dirty side;
(III) increasing the pressure differential between the clean side and the dirty side by filtering particulate matter and a fluid from an air flow within the test rig, wherein the particulate matter and the fluid combine to form a wet cake on the at least one filter element;
(IV) cleaning the at least one filter element; and
(V) repeating steps (II) through (IV) to replicate substantially the entire life cycle of the at least one filter element.

10. The method according to claim 9, further including the step of determining whether a filter media included within the at least one filter element has sufficient mechanical strength to resist tearing during the life cycle of the at least one filter element in order to predict the long-term life span of the at least one filter element.

11. The method according to claim 9, wherein the step of increasing the pressure differential between the clean side and the dirty side includes increasing the pressure differential to the greatest anticipated pressure differential that the at least one filter element is expected to experience during normal operation in the field.

12. The method according to claim 11, wherein the greatest anticipated pressure differential that the at least one filter element is expected to experience during normal operation in the field is within a range up to 3.738 kPa (15 inches water gauge).

13. The method according to claim 9, wherein the step of cleaning the at least one filter element includes using a pulse air system to deliver compressed air to the clean side of the at least one filter element.

14. The method according to claim 9, wherein steps (II) through (IV) are repeated with a relatively high frequency such that the entire life cycle of the at least one filter element can be replicated within a relatively short time period.

15. The method according to claim 14, wherein steps (II) through (IV) are repeated about 36,000 times to replicate substantially the entire life cycle of the at least one filter element.

16. The method according to claim 9, wherein the filter element is a cartridge filter.
